(19) United States
(12) Patent Application Publication
(10) Pub. No.: US 2026/0003076 A1
(43) Pub. Date: Jan. 1, 2026

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Reina Kadowaki, Tokyo (JP); Motoki Chiba, Tokyo (JP)

(21) Appl. No.: 19/250,193

(22) Filed: Jun. 26, 2025

(30) Foreign Application Priority Data
Jun. 28, 2024 (JP) 2024-104729

(51) Int. Cl. G01S 17/931; B60W 60/00

(52) U.S. Cl. CPC G01S 17/931; B60W 60/001; B60W 2420/408

(57) ABSTRACT

A vehicle control device acquires a first communication state of a first instruction line which is connected to a target utilized for controlling a vehicle and issues an instruction for power for the entire vehicle separately from a power supply line for supplying power to the target, acquires a second communication state of a second instruction line which is connected to the target and differs from the power supply line and the first instruction line, actuates the target when a first signal indicating the instruction for power in the first communication state has been input to the first instruction line or when the second communication state is normal, and does not actuate the target when the first signal indicating the instruction for power in the first communication state has not been input to the first instruction line and the second communication state is not normal.

### CROSS-REFERENCE TO RELATED APPLICATION

Priority is claimed on Japanese Patent Application No. 2024-104729, filed Jun. 28, 2024, the content of which is incorporated herein by reference.

### BACKGROUND

### Field of the Invention

The present invention relates to a vehicle control device, a vehicle control method, and a storage medium.

### Description of Related Art

In recent years, efforts to provide access to sustainable transportation systems taking vulnerable people among traffic participants into account have become active. In order to realize this, the efforts are focused on research and development for further improvement in traffic safety and convenience through research and development related to driving assistance technologies. In this regard, a vehicle control system having an external recognition device group and an actuator group, including first communication means for communication of first traveling control means for performing first traveling control of a vehicle with the external recognition device group, second communication means for communication of the first traveling control means with the actuator group, third communication means for communication of second traveling control means for performing second traveling control of the vehicle with the external recognition device group, and fourth communication means for communication of the second traveling control means with the actuator group has been disclosed (PCT International Publication No. WO2019/116459).

### SUMMARY

However, the foregoing system may not be able to sufficiently realize appropriate control of an actuation state of a target.

The present invention has been made in consideration of such circumstances, and an object thereof is to provide a vehicle control device, a vehicle control method, and a storage medium, in which an actuation state of a function of a target can be controlled appropriately. Further, this will ultimately contribute to development of sustainable transportation systems.

A vehicle control device, a vehicle control method, and a storage medium according to this invention employ the following constitutions.

(1): A vehicle control device according to an aspect of this invention includes a storage medium storing computer-readable instructions, and at least one processor connected to the storage medium. The processor executes the computer-readable instructions to: acquire a first communication state of a first instruction line which is connected to a target utilized for controlling a vehicle and issues an instruction for power for the entire vehicle separately from a power supply line for supplying power to the target, acquire a second communication state of a second instruction line which is connected to the target and differs from the power supply line and the first instruction line, actuate the target when a first signal indicating the instruction for power in the first communication state has been input to the first instruction line or when the second communication state is normal, and not actuate the target when the first signal indicating the instruction for power in the first communication state has not been input to the first instruction line and the second communication state is not normal.

(2): According to the aspect of the foregoing (1), the second communication state being normal denotes that a management control device connected to the second instruction line and controlling traveling of the vehicle has acquired a second signal input to the second instruction line.

(3): According to the aspect of the foregoing (1), the processor executes the computer-readable instructions to: activate the target when the first signal has been input, continue activation of the target when the first signal has been input or when the second communication state is normal, and stop actuation of the target when the first signal has not been input and the second communication state is not normal.

(4): According to the aspect of the foregoing (3), the target is a first target serving as a sensor, and the second instruction line is connected to the first target and a second target serving as a controller for controlling the sensor.

(5): According to the aspect of the foregoing (4), the processor executes the computer-readable instructions to: update a program, which is related to the first target and the second target and is stored in the second target, and not actuate the first target when the program stored in the second target is updated.

(6): According to any of the aspects of the foregoing (1) to (5), the target is a first target serving as a sensor of a LIDAR unit having a light emitter, and the second instruction line is connected to the first target and a second target serving as a controller for controlling the sensor of the LIDAR unit.

(7): According to the aspect of the foregoing (1), the processor executes the computer-readable instructions to: activate the target when the first signal has been input or when a management control device connected to the second instruction line and controlling traveling of the vehicle has acquired a second signal input to the second instruction line, continue activation of the target when the first signal or the second signal has been input, and stop actuation of the target when the first signal and the second signal have not been input.

(8): According to the aspect of the foregoing (7), the target is a first target serving as a control device controlling a sensor, and the second instruction line is connected to the first target and a second target serving as a management control device controlling traveling of the vehicle.

(9): A vehicle control device according to another aspect of this invention includes a storage medium storing computer-readable instructions, and at least one processor connected to the storage medium. The processor executes the computer-readable instructions to: acquire an input state of a first signal indicating that a power system of a vehicle has been activated with respect to a first instruction line connected to a sensor of a LIDAR unit, and a communication state of a second instruction line connected to a controller controlling the sensor of the LIDAR unit and the sensor, maintain a state in which the sensor is actuated when the first signal has been input or the communication state is normal, and stop actuation of the sensor when the first signal has not been input and the communication state is not normal.

(10): A vehicle control device according to another aspect of this invention includes a storage medium storing computer-readable instructions, and at least one processor connected to the storage medium. The processor executes the computer-readable instructions to: acquire an input state of a first signal indicating that a power system of a vehicle has been activated with respect to a first instruction line connected to a controller controlling a sensor of a LIDAR unit, and an input state of a second signal related to a communication state with respect to a second instruction line connected to the controller of the LIDAR unit and a management control device controlling traveling of the vehicle, maintain a state in which the controller is actuated when the first signal has been input or the second signal has been input, and stop actuation of the controller when the first signal has not been input and the second signal has not been input.

(11): A vehicle control method according to another aspect of this invention is a vehicle control method for causing a computer to acquire a first communication state of a first instruction line which is connected to a target utilized for controlling a vehicle and issues an instruction for power for the entire vehicle separately from a power supply line for supplying power to the target, acquire a second communication state of a second instruction line which is connected to the target and differs from the power supply line and the first instruction line, actuate the target when a first signal indicating the instruction for power in the first communication state has been input to the first instruction line or when the second communication state is normal, and not actuate the target when the first signal indicating the instruction for power in the first communication state has not been input to the first instruction line and the second communication state is not normal.

(12): A storage medium storing a program according to another aspect of this invention causes a computer to execute processing of acquiring a first communication state of a first instruction line which is connected to a target utilized for controlling a vehicle and issues an instruction for power for the entire vehicle separately from a power supply line for supplying power to the target, processing of acquiring a second communication state of a second instruction line which is connected to the target and differs from the power supply line and the first instruction line, and processing of not actuating the target when a first signal indicating the instruction for power in the first communication state has not been input to the first instruction line and the second communication state is not normal and actuating the target when the first signal indicating the instruction for power in the first communication state has been input to the first instruction line or when the second communication state is normal.

According to (1) to (12), it is possible for the vehicle control device to appropriately control an actuation state of a function of a target.

### BRIEF DESCRIPTION OF THE DRAWINGS

FIG. 1 is a view of the constitution of a vehicle system utilizing a vehicle control device according to an embodiment.

FIG. 2 is a view of a functional constitution of a first controller.

FIG. 3 is a view showing an example of processing executed by a first control device and a second control device.

FIG. 4 is a view showing an example of a functional constitution of a LIDAR unit.

FIG. 5 is an explanatory view of control related to an actuation state of a sensor unit.

FIG. 6 is a flowchart showing an example of a flow of processing executed by a sensor controller.

FIG. 7 is an explanatory view of control related to an actuation state of a control unit.

FIG. 8 is a flowchart showing another example of a flow of processing executed by the unit controller.

FIG. 9 is a timing chart (1) showing a transition between an input state and an actuation state of a signal of the control unit.

FIG. 10 is a timing chart (2) showing a transition between the input state and the actuation state of a signal of the control unit.

FIG. 11 is a timing chart (3) showing a transition between the input state and the actuation state of a signal of the control unit.

FIG. 12 is a timing chart (4) showing a transition between the input state and the actuation state of a signal of the control unit.

FIG. 13 is a timing chart (5) showing a transition between the input state and the actuation state of a signal of the control unit.

FIG. 14 is a timing chart (1) showing a transition between an input state and an actuation state of a signal of the sensor unit.

FIG. 15 is a timing chart (2) showing a transition between the input state and the actuation state of a signal of the sensor unit.

FIG. 16 is a timing chart (3) showing a transition between the input state and the actuation state of a signal of the sensor unit.

FIG. 17 is a timing chart (4) showing a transition between the input state and the actuation state of a signal of the sensor unit.

### DETAILED DESCRIPTION

Hereinafter, with reference to the drawings, an embodiment of a vehicle control device, a vehicle control method, and a storage medium of the present invention will be described.

### [Overall Constitution]

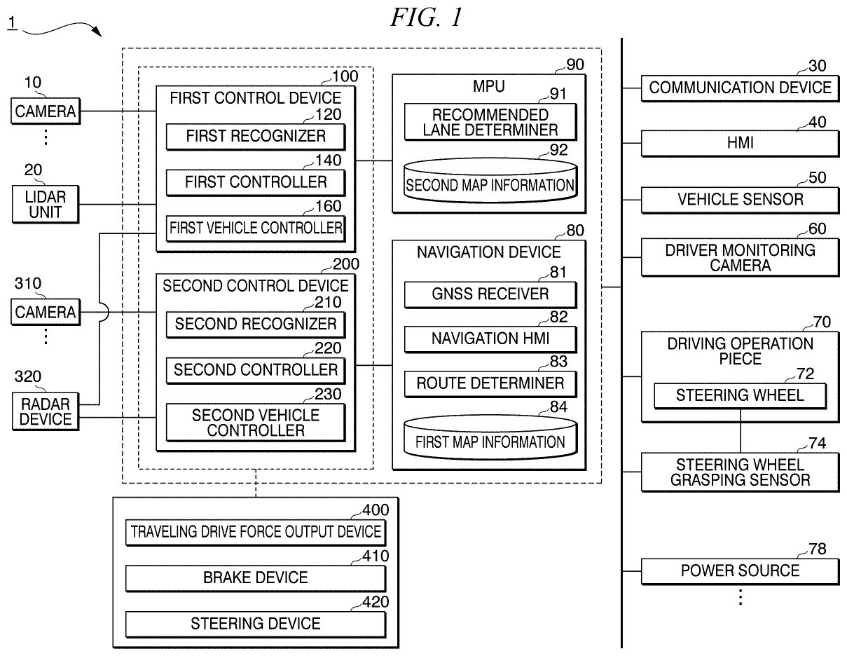

FIG. 1 is a view of the constitution of a vehicle system 1 utilizing a vehicle control device according to the embodiment. For example, a vehicle having the vehicle system 1 mounted therein is a vehicle having two wheels, three wheels, four wheels, or the like, and a drive source thereof is an internal-combustion engine such as a diesel engine or a gasoline engine, an electric motor, or a combination of these. An electric motor operates using power generated by a generator connected to the internal-combustion engine, or discharge power of a secondary battery or a fuel cell.

For example, the vehicle system 1 includes a camera 10, a light detection and ranging (LIDAR) unit 20, a communication device 30, a human machine interface (HMI) 40, a vehicle sensor 50, a driver monitoring camera 60, a driving operation piece 70, a steering wheel grasping sensor 74, a power source 78, a navigation device 80, a map positioning unit (MPU) 90, and a first control device 100.

Moreover, for example, the vehicle system 1 includes a second control device 200, a camera 310, a radar device 320, a traveling drive force output device 400, a brake device 410, and a steering device 420.

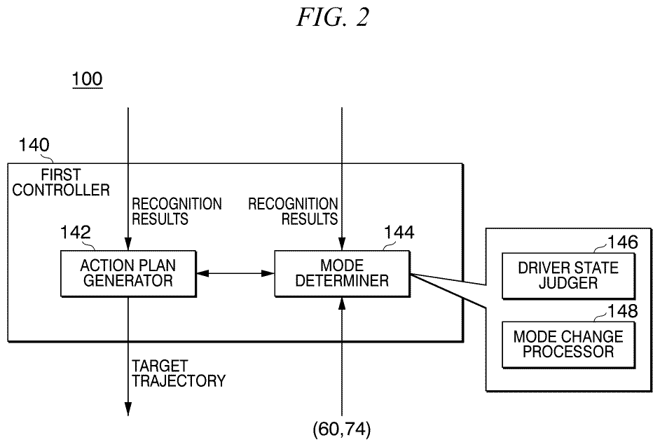

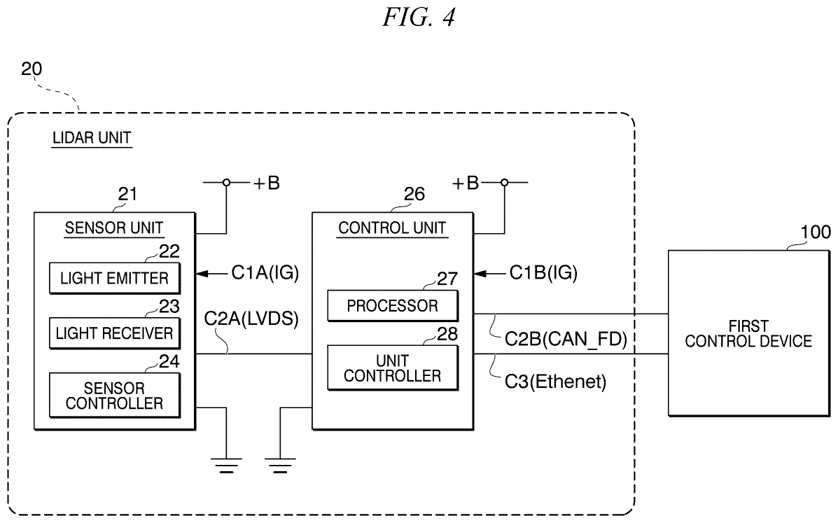

These devices and equipment are connected to each other through a multiplex communication line such as a controller area network (CAN) communication line, a serial communication line, a wireless communication network, or the like. The constituents shown in FIG. 1, and FIGS. 2 and 4 (which will be described below) are merely examples. A part of the constitutions may be omitted, and other constitutions may further be added thereto. The connection forms of the communication lines shown in FIG. 1, and FIGS. 2 and 4 (which will be described below) are merely examples, and the connection forms may be suitably changed. Moreover, the functional constitutions may be integrated or may be provided in a dispersed manner.

For example, the camera 10 is a digital camera utilizing a solid-state image capturing element such as a charge coupled device (CCD) or a complementary metal oxide semiconductor (CMOS). The camera 10 is attached to an arbitrary part in the vehicle having the vehicle system 1 mounted therein (hereinafter, a vehicle M). When images of the side in front thereof are captured, the camera 10 is attached to an upper part in a front windshield, a rear surface of a rearview mirror, or the like. For example, the camera 10 captures images of an area around the vehicle M periodically and repeatedly. The camera 10 may be a stereo camera.

The LIDAR unit 20 emits light (or electromagnetic waves having wavelengths close to that of light) to the area around the vehicle M and measures scattered light. The LIDAR unit 20 determines a distance to a target on the basis of a time from light emission to light reception. For example, emitted light is pulsed laser light. For example, a sensor unit 21 (which will be described below) of the LIDAR unit 20 is attached to a part in a location, such as a roof of the vehicle M, where information on the side in front of the vehicle M can be acquired. The LIDAR unit 20 may be attached to an arbitrary part in the vehicle M.

For example, the communication device 30 communicates with other vehicles present around the vehicle M utilizing a cellular network, a Wi-Fi network, Bluetooth (registered trademark), dedicated short range communication (DSRC), or the like, or communicates with various server devices via wireless base stations.

The HMI 40 presents various information to an occupant of the vehicle M and receives an input operation of the occupant. The HMI 40 includes various display devices, a speaker, a buzzer, a touch panel, a switch, a key, and the like. The HMI 40 may include a predetermined outputter which is provided in a steering wheel and prompts the occupant to grasp the steering wheel, or a head-up display (HUD).

The vehicle sensor 50 includes various sensors used for controlling the vehicle, such as a vehicle speed sensor for determining a speed of the vehicle M, an acceleration sensor for determining an acceleration, a yaw rate sensor for determining an angular velocity around a vertical axis, and an azimuth sensor for determining a direction of the vehicle M.

For example, the driver monitoring camera 60 is a digital camera utilizing a solid-state image capturing element such as a CCD or a CMOS. The driver monitoring camera 60 is attached to an arbitrary part in the vehicle M in a location and a direction in which an image of the head of an occupant (hereinafter, a driver) seated in a driver's seat of the vehicle M can be captured from the front (in a direction in which an image of the face is captured). For example, the driver monitoring camera 60 is attached to an upper part of the display device provided in a central part of an instrument panel of the vehicle M.

For example, in addition to a steering wheel 72, the driving operation piece 70 includes an accelerator pedal, a brake pedal, a shift lever, and other operation pieces. A sensor for determining an operation amount or the presence or absence of an operation is attached to the driving operation piece 70, and determination results thereof are output to the first control device 100 and the second control device 200, or some or all of the traveling drive force output device 400, the brake device 410, and the steering device 420. The steering wheel grasping sensor 74 is attached to the steering wheel 72. The steering wheel grasping sensor 74 is realized by an electrostatic capacity sensor or the like and outputs a signal capable of determining whether or not the driver is grasping the steering wheel 72 (is in contact with the steering wheel 72 in a state in which a force can be applied thereto) to the first control device 100 or the second control device 200.

The power source 78 is a battery supplying power to the vehicle system 1. The power source 78 may include a plurality of batteries and may be constituted to be redundant such that when a failure occurs in one battery, power is supplied from other batteries.

For example, the navigation device 80 includes a global navigation satellite system (GNSS) receiver 81, a navigation HMI 82, and a route determiner 83. The navigation device 80 retains first map information 84 in a storage device such as a hard disk drive (HDD) or a flash memory. The GNSS receiver 81 identifies the location of the vehicle M on the basis of a signal received from a GNSS satellite. The location of the vehicle M may be identified or complemented by an inertial navigation system (INS) utilizing an output of the vehicle sensor 50. The navigation HMI 82 includes a display device, a speaker, a touch panel, a key, and the like. A part or the entirety of the navigation HMI 82 may be shared by the HMI 40 described above. For example, with reference to the first map information 84, the route determiner 83 determines a route from the location of the vehicle M (or an arbitrary input location) identified by the GNSS receiver 81 to a destination input by the occupant using the navigation HMI 82 (hereinafter, a route on the map). For example, the first map information 84 is information in which road shapes are expressed by links indicating roads and nodes connected to each other by the links. The first map information 84 may include curvatures of roads, information on point of interest (POI), and the like. The route on the map is output to the MPU 90. The navigation device 80 may perform route guiding using the navigation HMI 82 on the basis of the route on the map. For example, the navigation device 80 may be realized by a function of a terminal device such as a smartphone or a tablet terminal carried by the occupant. The navigation device 80 may transmit a current location and a destination to a navigation server via the communication device 30 and acquire a route equivalent to the route on the map from the navigation server.

For example, the MPU 90 includes a recommended lane determiner 91 and retains second map information 92 in a storage device such as an HDD or a flash memory. The recommended lane determiner 91 divides a route on the map provided from the navigation device 80 into a plurality of blocks (for example, divides it into blocks of 100 [m] in a vehicle proceeding direction) and determines a recommended lane for each block with reference to the second map information 92. The recommended lane determiner 91 determines in which lane from the left the vehicle should travel. When a branching point is present in the route on the map, the recommended lane determiner 91 determines a recommended lane such that the vehicle M can travel along a reasonable route to proceed to a branch destination. The MPU 90 recognizes the location of the vehicle M on the basis of determination results of a gyro sensor (not shown), the location of the vehicle M identified by the GNSS receiver 81, or the like.

The second map information 92 is more detailed map information than the first map information 84. For example, the second map information 92 includes information on the centers of lanes, information on boundaries of lanes, and the like. The second map information 92 may include road information, traffic regulation information, address information (addresses and zip codes), facility information, phone number information, and the like. The second map information 92 may be updated at any time by the communication device 30 through communication with other devices. Information indicating locations or ranges of zebra zones (buffer zones) is stored in the second map information 92. Zebra zones are road signs for inducing traveling of the vehicle. For example, zebra zones are signs expressed by a stripe pattern.

### [First Control Device]

For example, the first control device 100 includes a first recognizer 120, a first controller 140, and a first vehicle controller 160. For example, each of the first recognizer 120, the first controller 140, and the first vehicle controller 160 is realized by a hardware processor such as a central processing unit (CPU) executing a program (software). Some or all of these constituent elements may be realized by hardware (circuit; including circuitry), such as a large scale integration (LSI), an application specific integrated circuit (ASIC), a field-programmable gate array (FPGA), a graphics processing unit (GPU), or system on chip (SOC), or may be realized by software and hardware in cooperation. The program may be stored in a device such as an HDD or a flash memory (a storage device including a non-transitory storage medium) of the first control device 100 in advance or may be stored in an attachable/detachable storage medium such as a DVD or a CD-ROM such that the program is installed in the HDD or the flash memory of the first control device 100 when the storage medium (non-transitory storage medium) is mounted in a drive device.

The first recognizer 120 recognizes the location, the kind, the speed, and the like of an object by performing sensor fusion processing with respect to determination results of some or all of the camera 10 and the LIDAR unit 20. This function may be included in the LIDAR unit 20 or may be provided as a constitution different from the LIDAR unit 20 and the first control device 100. The first recognizer 120 may perform the sensor fusion processing by further using determination results of the camera 310 or the radar device 320, which will be described below.

For example, the location of an object is recognized as a location on absolute coordinates with an origin at a representative point (centroid, drive shaft center, or the like) in the vehicle M and is used for control. The location of an object may be indicated by a representative point such as a centroid or a corner of the object or may be indicated as a expressed region. A “state” of an object may include an acceleration or a jerk of the object, or “an action state” (for example, whether or not it is performing a lane change or attempting a lane change).

For example, the first recognizer 120 recognizes a lane in which the vehicle Mis traveling (traveling lane). For example, the first recognizer 120 recognizes a traveling lane by comparing the pattern of a road division line (for example, an array of solid lines and dashed line) obtained from the second map information 92 with the pattern of the road division line around the vehicle M recognized from images captured by the camera 10. The first recognizer 120 may recognize a traveling lane by recognizing traveling path boundaries (road boundaries) including road division lines, road shoulders, curbstones, median strips, guardrails, and the like without being limited to road division lines. In this recognition, the location of the vehicle M acquired from the navigation device 80 or processing results of the INS may be added. The first recognizer 120 recognizes stop lines, obstacles, red lights, toll gates, and other road events.

When recognizing a traveling lane, the first recognizer 120 recognizes the location and the posture of the vehicle M with respect to the traveling lane. For example, the first recognizer 120 may recognize a deviation of a reference point in the vehicle M from the center of the lane, and an angle formed with respect to a line of the centers of the lane of the vehicle M in the proceeding direction as a relative location and a posture of the vehicle M with respect to the traveling lane. Instead of this, the first recognizer 120 may recognize a location or the like of a reference point in the vehicle M with respect to any side end part (road division line or road boundary) of the traveling lane as a relative location of the vehicle M with respect to the traveling lane.

For example, the first recognizer 120 realizes a function based on artificial intelligence (AI) and a function based on a model given in advance in parallel. For example, the function of “recognizing an intersection” may be realized by executing recognition of an intersection based on deep learning or the like and recognition based on conditions given in advance (including signals allowing pattern matching, road signs, and the like) in parallel and scoring both for comprehensive evaluation. Accordingly, the reliability of automated driving (traveling control) is secured. The first recognizer 120 may be omitted, and processing results of a second recognizer 210 (which will be described below) may be utilized.

FIG. 2 is a view of a functional constitution of the first controller 140. For example, the first controller 140 includes an action plan generator 142 and a mode determiner 144.

The action plan generator 142 basically generates a target trajectory in which the vehicle M will automatically travel (without depending on an operation of the driver) in the future such that it travels in a recommended lane determined by the recommended lane determiner 91 and can also cope with surrounding circumstances of the vehicle M. For example, a target trajectory includes a speed factor. For example, a target trajectory is expressed as arrival target points (trajectory points) of the vehicle M arranged in order. Trajectory points are arrival target points of the vehicle M for each predetermined traveling distance (for example, approximately several meters) by the distance along the road. In addition to this, the target speed and the target acceleration for each predetermined sampling time (for example, approximately several tenths of a second) are generated as a part of the target trajectory. The trajectory points may be arrival target locations of the vehicle M at corresponding sampling times of respective predetermined sampling times. In this case, information on the target speed and the target acceleration is expressed by an interval between the trajectory points.

When a target trajectory is generated, the action plan generator 142 may set an event of automated driving. An event of automated driving includes a constant speed traveling event, a low-speed following traveling event, a lane change event, a branching event, a merging event, a takeover event, and the like. The action plan generator 142 generates a target trajectory corresponding to an activated event.

The mode determiner 144 determines any of a plurality of driving modes having different tasks imposed on the driver as a driving mode of the vehicle M. For example, the mode determiner 144 includes a driver state judger 146 and a mode change processor 148.

The vehicle system 1 can execute a plurality of driving modes of the vehicle M. For example, the plurality of driving modes are modes with different control states, that is, different degrees of automation in driving control of the vehicle M. A higher degree of automation denotes that the vehicle system 1 has a higher degree of control over the vehicle M, in other words, the driver has a lower degree of intervention in control of the vehicle M (driving operation). The task imposed on the driver varies depending on the degree of automation. For example, the higher the degree of automation, the lighter the task. Examples of tasks include monitoring the side in front by the driver, grasping the steering wheel 72, and an operation for acceleration/deceleration. For example, in a driving mode with a higher degree of automation, automated driving is executed while the driver is not required to monitor the side in front, grasp the steering wheel 72, and perform an operation for acceleration/deceleration, for example. Automated driving denotes that both steering and acceleration/deceleration are controlled without depending on an operation of the driver. The side in front denotes a space visually recognized in the proceeding direction of the vehicle M through the front windshield. For example, when conditions that the vehicle M is traveling at a predetermined speed (for example, approximately 60 [km/h]) or lower on a motorway such as an expressway and there is a preceding vehicle to be followed are satisfied, a driving mode in which none of the foregoing tasks are imposed on the driver is executed. This driving mode may also be referred to as a traffic jam pilot (TJP). When the conditions are no longer satisfied, the mode determiner 144 changes the driving mode to a different driving mode. For example, the first vehicle controller 160 executes junction passing control and merging control of the vehicle M. Junction passing control is control for causing the vehicle M to travel while maintaining a lane within a junction or selecting a lane within a junction in which the vehicle M travels. Merging control is control for causing the vehicle M to make a lane change to a merging lane when the vehicle M merges into a main lane from the merging lane.

When the task related to a determined driving mode (hereinafter, a current driving mode) is not executed by the driver, the mode determiner 144 changes the driving mode of the vehicle M to a driving mode with a heavier task. For example, when the driver is in a posture in which he/she cannot shift to manual driving in response to a request from the system in a driving mode with a higher degree of automation (for example, when the driver continues to look aside other than permitted areas or when signs of difficulty in driving are determined), the mode determiner 144 prompts the driver to shift to manual driving using the HMI 40 or a predetermined outputter prompting the occupant to grasp the steering wheel, and if the driver does not respond, the mode determiner 144 performs control such as pulling over the vehicle M to a road shoulder, gradually stopping the vehicle M, and stopping the automated driving. After automated driving is stopped, the vehicle M shifts to a driving mode with a lower degree of automation so that the driver can start the vehicle M by a manual operation. Hereinafter, the same applies to “stopping automated driving”.

The driver state judger 146 monitors the state of the driver for the foregoing mode change and judges whether or not the state of the driver is a state corresponding to the task. For example, the driver state judger 146 performs posture estimation processing by analyzing images captured by the driver monitoring camera 60 and judges whether or not the driver is in a posture in which he/she cannot shift to manual driving in response to a request from the system. The driver state judger 146 performs visual line estimation processing by analyzing images captured by the driver monitoring camera 60 and judges whether or not the driver is monitoring the side in front.

The mode change processor 148 performs various processing for mode change. For example, the mode change processor 148 instructs the action plan generator 142 to generate a target trajectory for stopping at a road shoulder, instructs the second control device 200 to be actuated, or controls the HMI 40 to prompt the driver to perform an action.

The first vehicle controller 160 controls the traveling drive force output device 400, the brake device 410, and the steering device 420 such that the vehicle M passes through a target trajectory generated by the action plan generator 142 at a scheduled time. The first vehicle controller 160 may provide information on the target trajectory to the second control device 200 and control the traveling drive force output device 400, the brake device 410, and the steering device 420 via the second control device 200. The second control device 200 may have one or both of the function of the first controller 140 and the function of the first vehicle controller 160 described above.

The traveling drive force output device 400 outputs a traveling drive force (torque) for causing the vehicle to travel to driving wheels. For example, the traveling drive force output device 400 is a combination of an internal-combustion engine, an electric motor, a transmission, and the like.

For example, the brake device 410 includes a brake caliper, a cylinder transmitting a hydraulic pressure to the brake caliper, and an electric motor generating a hydraulic pressure in the cylinder. The brake device 410 may include a mechanism, as a backup, for transmitting a hydraulic pressure generated by an operation of the brake pedal included in the driving operation piece 70 to the cylinder via a master cylinder. The brake device 410 is not limited to the constitution described above and may be an electronic control hydraulic brake device transmitting a hydraulic pressure of the master cylinder to the cylinder by controlling an actuator in accordance with the information input from a second controller 220.

For example, the steering device 420 includes an electric motor. For example, the electric motor changes the direction of steered wheels by causing a force to act by a rack-and-pinion mechanism.

Description returns to FIG. 1. For example, the camera 310 is a digital camera utilizing a solid-state image capturing element such as a CCD or a CMOS. The camera 310 is attached to an arbitrary part in the vehicle M. For example, the camera 310 captures images of an area around the vehicle M periodically and repeatedly. The camera 310 may be a stereo camera.

The radar device 320 radiates radio waves such as millimeter waves around the vehicle M and determines at least the location (distance and azimuth) of an object by determining radio waves (reflected waves) reflected by the object. The radar device 320 is attached to an arbitrary part in the vehicle M. The radar device 320 may detect the location and the speed of an object by a frequency modulated continuous wave (FM-CW) method.

For example, the second control device 200 includes the second recognizer 210, the second controller 220, and a second vehicle controller 230. For example, the second recognizer 210, the second controller 220, and the second vehicle controller 230 are realized by a hardware processor such as a CPU executing a program (software). Some or all of these constituent elements may be realized by hardware (circuit; including circuitry), such as an LSI, an ASIC, an FPGA, a GPU, or an SOC, or may be realized by software and hardware in cooperation. The program may be stored in a device such as an HDD or a flash memory (a storage device including a non-transitory storage medium) of the second control device 200 in advance or may be stored in an attachable/detachable storage medium such as a DVD or a CD-ROM such that the program is installed in the HDD or the flash memory of the second control device 200 when the storage medium (non-transitory storage medium) is mounted in a drive device.

The second recognizer 210 recognizes the location, the kind, the speed, and the like of an object by performing sensor fusion processing with respect to determination results of some or all of the camera 310 and the radar device 320. For example, the second recognizer 210 may have a function similar to that of the first recognizer 120. The second recognizer 210 may utilize the determination results of the camera 10 or the LIDAR unit 20 in the sensor fusion processing. The second recognizer 210 may be omitted, and the processing results of the first recognizer 120 described above may be utilized.

The second controller 220 executes control of assisting driving of the driver. The second controller 220 generates a target trajectory in which the vehicle M will travel in the future. Similar to the first controller 140, the second controller 220 may execute automated driving of the vehicle M. The processing performance of the first vehicle controller 160 (first control device 100) is higher than the processing performance of the second controller 220 (second control device 200). For example, the first controller 140 is responsible for control of the vehicle M with a higher degree of automation, and the second controller 220 is responsible for control of the vehicle M with a comparatively lower degree of automation. For example, in a state in which the driver is monitoring the side in front, the second controller 220 executes driving assistance such as adaptive cruise control (ACC) or a lane keeping assist system (LKAS). For example, the second controller 220 executes automatic lane change control, diverging control of causing the vehicle M to make a lane change from a main lane to a branch lane, and the like.

For example, the second vehicle controller 230 acquires information on a target trajectory (trajectory points) and stores it in a memory (not shown). The second vehicle controller 230 controls the traveling drive force output device 400 and controls the brake device 410 on the basis of the speed factor associated with the target trajectory stored in the memory. The second vehicle controller 230 controls the steering device 420 in accordance with the curve state of the target trajectory stored in the memory. For example, the processing of the second vehicle controller 230 is realized by a combination of feedforward control and feedback control. As an example, the second vehicle controller 230 executes feedforward control in accordance with the curvature of the road on the side in front of the vehicle M and feedback control based on the deviation from the target trajectory in combination.

### [Processing Executed by First Control Device and Second Control Device]

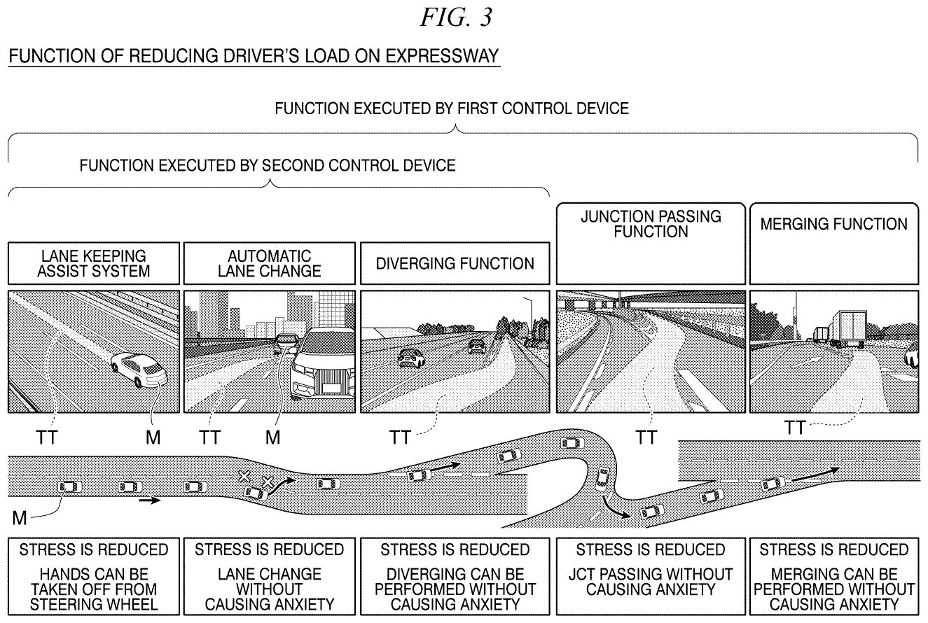

FIG. 3 is a view showing an example of processing executed by the first control device 100 and the second control device 200. The example of FIG. 4 shows control for “a function of reducing a driver's load on an expressway”. The first control device 100 can execute the lane keeping assist system (LKAS), automatic lane change (ALC), diverging function (lane change to a branching retreat lane), junction (JCT) passing function, merging function, and the like during traveling on an expressway, and all of these reduce the driver's stress by reducing the load during driving. In this control, the first control device 100 generates a target trajectory TT in which the vehicle M will travel in the future and executes driving control such that the vehicle M travels along the generated target trajectory TT. In this manner, by executing each of the functions described above, for example, the lane keeping assist system of the functions allows the occupant to take off his/her hands from the steering wheel 72, and other functions enable the vehicle M to execute lane change, diverging, JCT passing, and merging without causing any anxiety to the occupant. In the example of FIG. 4, the second control device 200 can execute the lane keeping assist system, the automatic lane change, and the diverging function and does not execute the JCT passing function and the merging function. Regarding each of the functions in the second control device 200, for example, the occupant is notified of inquiry information as to whether or not to execute the function, and whether or not to execute it is determined by an instruction of the occupant thereafter. As described above, the driver's load is reduced by the function of the first control device 100 or the second control device 200.

### [LIDAR Unit]

FIG. 4 is a view showing an example of a functional constitution of the LIDAR unit 20. The LIDAR unit 20 includes the sensor unit 21 and a control unit 26. The sensor unit 21 and the control unit 26 are actuated by power supplied from the power source 78.

A first communication line C1A is connected to the sensor unit 21. The first communication line C1A is a communication line through which a signal indicating that an ignition (IG) of the vehicle M is in a state of being turned on is input. The ignition being turned on denotes a state in which the vehicle system 1 of the vehicle M has been activated, a state in which a predetermined electric system has been activated, a state in which the engine has been activated, or the like.

The sensor unit 21 and the control unit 26 are connected to each other through a second communication line C2A. The sensor unit 21 and the control unit 26 transmit and receive information through the second communication line C2A. For example, the second communication line C2A is a communication line for performing communication conforming to the communication standard, such as low voltage differential signaling (LVDS), but it is not limited to this.

A first communication line C1B is connected to the control unit 26. The first communication line C1B is a communication line through which a signal indicating that the ignition (IG) of the vehicle Mis in a state of being turned on is input. For example, a trigger for outputting a signal indicating that the ignition (IG) of the vehicle M is in a state of being turned on is the same as a trigger of the sensor unit 21 for a signal indicating that the ignition (IG) of the vehicle M is in a state of being turned on.

The control unit 26 and the first control device 100 are connected to each other via a second communication line C2B. The control unit 26 and the first control device 100 transmit and receive information through the second communication line C2B. For example, the second communication line C2B is a communication line for performing communication conforming to the communication standard, such as CAN FD, but it is not limited to this. Moreover, the control unit 26 and the first control device 100 are connected to each other via a third communication line. The third communication line is a communication line for performing communication conforming to the communication standard (for example, Ethernet) different from the second communication line C2B.

For example, the sensor unit 21 includes a light emitter 22, a light receiver 23, and a sensor controller 24. The light emitter 22 emits light to a target. The light receiver 23 receives scattered light corresponding to the emitted light. The sensor controller 24 transmits various processing results in the sensor unit 21, such as processing results of the light emitter 22 and processing results of the light receiver 23, to the control unit 26.

For example, the sensor controller 24 is realized by a hardware processor such as a CPU executing a program (software). The sensor controller 24 may be realized by hardware (circuit; including circuitry), such as an LSI, an ASIC, an FPGA, a GPU, or an SOC, or may be realized by software and hardware in cooperation. The program may be stored in a storage device such as an HDD or a flash memory (a storage device including a non-transitory storage medium) of the sensor unit 21. The sensor controller 24 controls actuation of the sensor unit 21 on the basis of the communication state of the first communication line C1A and the communication state of the second communication line C2A.

For example, the control unit 26 includes a processor 27 and a unit controller 28. For example, one or both of the processor 27 and the unit controller 28 are realized by a hardware processor such as a CPU executing a program (software). These functional constitutions may be realized by hardware (circuit; including circuitry), such as an LSI, an ASIC, an FPGA, a GPU, or an SOC, or may be realized by software and hardware in cooperation. The program may be stored in a storage device such as an HDD or a flash memory (a storage device including a non-transitory storage medium) of the control unit 26.

The processor 27 determines a target object with reference to information acquired from the sensor unit 21. For example, the processor 27 identifies the location of a target object by determining the distance to the target object on the basis of the time from light emission to light reception. A part of the function of the processor 27 may be mounted in the first recognizer 120. The unit controller 28 controls actuation of the control unit 26 on the basis of the communication state of the first communication line C1B and the communication state of the second communication line C2B.

In the following description, as an example, the second communication line C2A is an LVDS communication line, and the second communication line C2B is a CAN FD communication line.

### [Control Related to Actuation State of Sensor Unit]

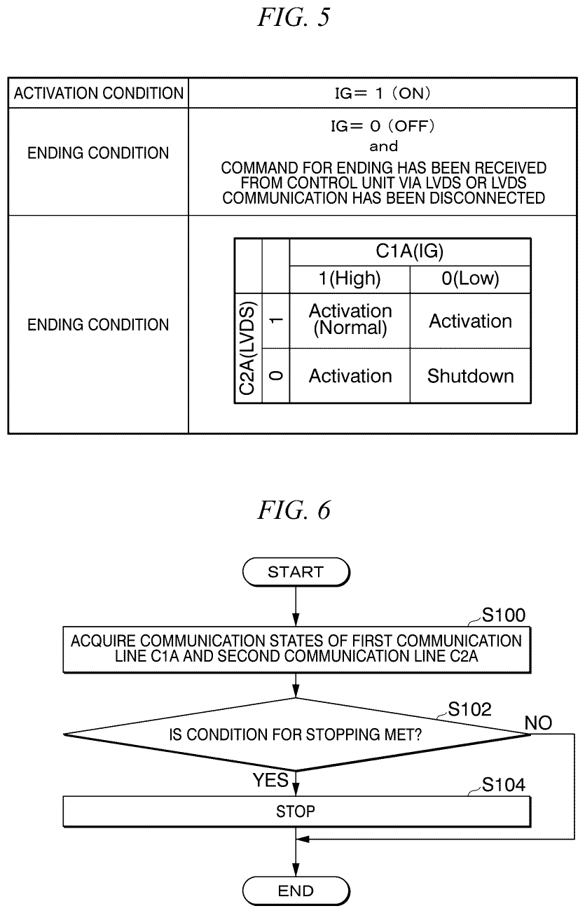

FIG. 5 is an explanatory view of control related to an actuation state of the sensor unit 21. The sensor controller 24 (vehicle control device) acquires a first communication state of the first communication line C1A (first instruction line) which is connected to the sensor unit 21 utilized for controlling the vehicle M and issues an instruction for power for the entire vehicle M separately from a power supply line for supplying power to the sensor unit 21, and acquires a second communication state of the second communication line C2A (second instruction line) which is connected to the sensor unit 21 and differs from the power supply line and the first communication line C1A (first instruction line). The sensor unit 21 is an example of “a sensor”. The control unit 26 is an example of “a controller”.

When a signal indicating that the ignition is turned on (first signal indicating an instruction for power) in the first communication state has been input to the first communication line C1A (first instruction line) or when the second communication state is normal, the sensor controller 24 actuates the sensor unit 21 (for example, the light emitter 22 or the light receiver 23). When a signal indicating that the ignition is turned on (first signal indicating an instruction for power) in the first communication state has not been input to the first communication line C1A (first instruction line) and the second communication state is not normal, the sensor controller 24 does not actuate the sensor unit 21.

### (Activation Condition)

When an activation condition has been met, the sensor controller 24 activates the sensor unit 21. The activation condition is that a predetermined signal (first signal) has been input to the sensor controller 24. A predetermined signal is a signal transmitted via the first communication line C1A and indicating that the ignition has been turned on (ON signal, “1”).

### (Ending Condition)

When the following ending condition has been met, the sensor controller 24 ends actuation of the sensor unit 21. The ending condition is that a predetermined signal related to the activation condition has not been input and at least one of that (a) and (b) have been satisfied.

(a) A signal of a command for ending has been received from the control unit 26.

(b) Communication with the control unit 26 has been disconnected (a state in which communication utilizing the second communication line C2A cannot be performed).

The state satisfying (a) or (b) is an example of “a state in which the second communication state is normal”.

### (Actuation State for Each State)

The sensor controller 24 activates the sensor unit 21 when an ignition-on signal (first signal) has been input, continues activation of the sensor unit 21 when an ignition-on signal (first signal) has been input or when the communication state of the second communication line C2A (second communication state) is normal, and stops actuation of the sensor unit 21 when an ignition-on signal (first signal) has not been input and the communication state of the second communication line C2A (second communication state) is not normal.

(1) When “1” has been input to the first communication line C1A and “1” has been input to the second communication line C2A, the sensor controller 24 maintains the actuation state (“Activation”) of the sensor unit 21. This state is a normal state.

(2) When “1” has been input to the first communication line C1A and the second communication line C2A is not normal (when “0”), the sensor controller 24 maintains the actuation state of the sensor unit 21. In this case, the sensor unit 21 may transition to an idling state. An idling state denotes that the sensor unit 21 is not in a state of executing the processing and only the power is in a state of being turned on. In this manner, even when the second communication line C2B is not normal, the actuation state is maintained. For example, even when the communication state of the second communication line C2A is no longer normal from the actuation state of (1), when the ON signal “1” of the ignition has been input, the actuation state is maintained.

(3) When no signal has been input to the first communication line C1A (when “0”) and the second communication line C2A is normal (when “1”), the sensor controller 24 maintains the actuation state of the sensor unit 21. In this manner, even when no signal has been input to the first communication line C1A, the actuation state is maintained.

(4) When the ON signal “1” has not been input to the first communication line C1A and the communication state of the second communication line C2A is not normal (when “0”), the sensor controller 24 ends (shuts down) actuation of the sensor unit 21.

When a program related to the sensor unit 21 and the control unit 26 (for example, a program utilized for control) is updated, the program stored in the control unit 26 is updated. In this case, actuation of the sensor unit 21 may be stopped or may be controlled to be stopped. For example, the unit controller 28 or a device included in the vehicle system 1 turns off the ignition such that the ending condition is satisfied in order to stop actuation of the sensor unit 21, and a signal of a command for ending is transmitted to the sensor unit 21.

FIG. 6 is a flowchart showing an example of a flow of processing executed by the sensor controller 24. This processing is repeatedly executed at a predetermined interval. This processing is processing executed after the sensor unit 21 is activated.

The sensor controller 24 acquires the communication states of the first communication line C1A and the second communication line C2A (Step S100). The sensor controller 24 judges whether or not a condition for stopping actuation of the sensor unit 21 is met on the basis of the communication states (Step S102). When the condition for stopping actuation of the sensor unit 21 is not met, the processing of Step S104 is skipped. When the condition for stopping actuation of the sensor unit 21 is met, the sensor controller 24 stops actuation of the sensor unit 21 (Step S104). Accordingly, processing for one routine of this flowchart ends.

As described above, the sensor controller 24 can appropriately control the actuation state of the sensor unit 21 in accordance with the communication states of the first communication line C1A and the second communication line C2A. For example, even when an ignition-on signal is interrupted or a problem occurs in communication through the second communication line C2A, the sensor unit 21 of the present embodiment continues to be actuated without stopping the actuation, and therefore the first control device 100 or the second control device 200 can appropriately control the vehicle M utilizing the processing results of the sensor unit 21.

### [Control Related to Actuation State of Control Unit]

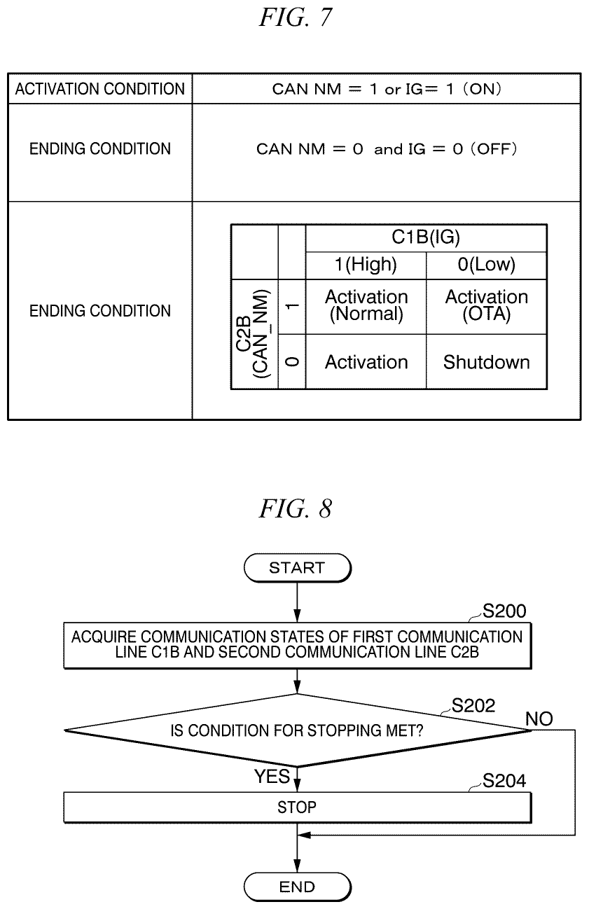

FIG. 7 is an explanatory view of control related to an actuation state of the control unit 26. The unit controller 28 (vehicle control device) acquires the first communication state of the first communication line C1B (first instruction line) which is connected to the control unit 26 utilized for controlling the vehicle M and issues an instruction for power for the entire vehicle M separately from the power supply line for supplying power to the control unit 26, and acquires the second communication state of the second communication line C2B (second instruction line) which is connected to the control unit 26 and differs from the power supply line and the first communication line C1B (first instruction line). The control unit 26 is an example of “a control device controlling a sensor”. The first control device 100 is an example of “a management control device”.

When a signal indicating that the ignition is turned on (first signal indicating an instruction for power) in the first communication state has been input to the first communication line C1B (first instruction line) or when the second communication state is normal, the unit controller 28 actuates the control unit 26 (for example, the processor 27). When a signal indicating that the ignition is turned on (first signal indicating an instruction for power) in the first communication state has not been input to the first communication line C1B (first instruction line), and the second communication state is not normal, the unit controller 28 does not actuate the control unit 26.

### (Activation Condition)

When an activation condition has been met, the unit controller 28 activates the control unit 26. The activation condition is that a predetermined signal has been input to the unit controller 28. A predetermined signal is a signal transmitted via the first communication line C1B and indicating that the ignition has been turned on (ON signal, “1”), or a signal “1” transmitted via the second communication line C2B (CAN NM=1, which is a signal of CAN FD).

### (Ending Condition)

When the following ending condition has been met, the unit controller 28 ends actuation of the control unit 26. The ending condition is that the foregoing predetermined signal has not been input or that a signal indicating the ending condition has been input. For example, when the state of a signal transmitted via the first communication line C1A is “0” and the state of a signal transmitted via the second communication line C2A is “0” (CAN NM=0, which is a signal of CAN FD), the unit controller 28 ends actuation of the control unit 26.

### (Actuation State for Each State)

The unit controller 28 activates the control unit 26 (for example, the processor 27) when an ignition-on signal (first signal) has been input, and activates the control unit 26 when an ignition-on signal (first signal) has been input or when the first control device 100 (management control device) connected to the second communication line C2B (second instruction line) and controlling traveling of the vehicle M has input a predetermined signal (signal of CAN NM=1: second signal) to the second communication line C2B (second instruction line). The unit controller 28 continues actuation of the control unit 26 when an ignition-on signal or a predetermined signal (signal of CAN NM=1) has been input, and stops actuation of the control unit 26 when an ignition-on signal and a predetermined signal (signal of CAN NM=1) has not been input.

(1) When “1” has been input to the first communication line C1B and “1” has been input to the second communication line C2B, the unit controller 28 maintains the actuation state (“Activation”) of the control unit 26. This state is a normal state.

(2) When “1” has been input to the first communication line C1B and no signal has been input to the second communication line C2B (when “0”), the unit controller 28 maintains the actuation state of the control unit 26. In this manner, even when no signal has been input to the second communication line C2B, the actuation state is maintained.

(3) When no signal has been input to the first communication line C1B (when “0”) and “1” has been input to the second communication line C2B, the unit controller 28 maintains the actuation state of the control unit 26. In this manner, even when no signal has been input to the first communication line C1B, the actuation state is maintained. For example, since actuation of the control unit 26 is maintained in a state in which no signal has been input to the first communication line C1B, the program stored in a storage (not shown) of the control unit 26 can be updated over the air (OTA). During OTA, the sensor unit 21 may be stopped.

(4) When no signal has been input to the first communication line C1B and the second communication line C2B (when “0”), the unit controller 28 ends (shuts down) actuation of the sensor unit 21.

FIG. 8 is a flowchart showing another example of a flow of processing executed by the unit controller 28. This processing is repeatedly executed at a predetermined interval. This processing is processing executed after the control unit 26 is activated.

The unit controller 28 acquires the communication states of the first communication line C1B and the second communication line C2B (Step S200). The unit controller 28 judges whether or not a condition for stopping actuation of the control unit 26 is met on the basis of the communication states (Step S202). When the condition for stopping actuation of the control unit 26 is not met, the processing of Step S204 is skipped. When the condition for stopping actuation of the control unit 26 is met, the unit controller 28 stops actuation of the control unit 26 (Step S204). Accordingly, processing for one routine of this flowchart ends.

As described above, the unit controller 28 can appropriately control the actuation state of the control unit 26 in accordance with the communication states of the first communication line C1B and the second communication line C2B. For example, even when an ignition-on signal is interrupted or a problem occurs in communication through the second communication line C2B, the control unit 26 of the present embodiment continues to be actuated without stopping the actuation, and therefore the first control device 100 or the second control device 200 can appropriately control the vehicle M utilizing the processing results of the control unit 26.

### [Timing Chart (1)]

### (Control Unit (1))

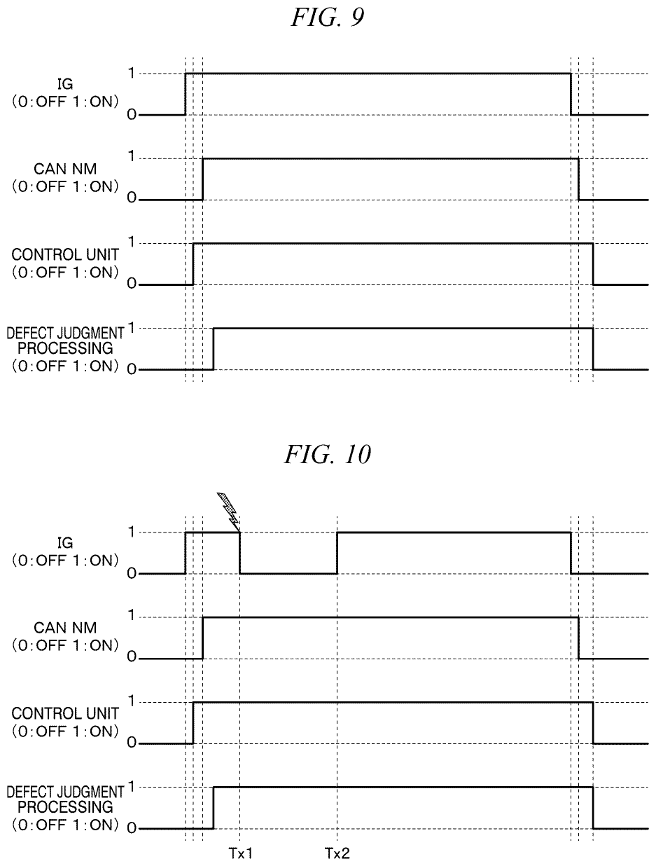

FIG. 9 is a timing chart (1) showing transition between an input state and an actuation state of a signal of the control unit 26. In the following description, a signal input to the first communication line C1B will be referred to as IG “1”, and a signal input to the second communication line C2B will be referred to as CAN NM “1”. An actuation state in which the control unit 26 is actuated will be referred to as “1”, and a stopped state in which it is stopped will be referred to as “0”. A state in which defect judgment processing has been executed will be referred to as “1”, and a state in which it has not been executed will be referred to as “0”. The defect judgment processing is processing executed by the unit controller 28 to actuate or stop the control unit 26 in accordance with the input state of a signal (for example, processing of the flowchart in FIG. 8).

If IG “1” is input, the control unit 26 is actuated. Thereafter, if CAN NM “1” is input, the defect judgment processing is started. Thereafter, if IG becomes “0” and CAN NM becomes “0”, the control unit 26 stops and the defect judgment processing ends.

### (Control Unit (2))

FIG. 10 is a timing chart (2) showing transition between the input state and the actuation state of a signal of the control unit 26. Description will focus on points different from those in FIG. 9. After the defect judgment processing has started, it is assumed that IG becomes “0” during a period from a time T×1 to a time T×2. In this case as well, the control unit 26 maintains the actuation state.

### (Control Unit (3))

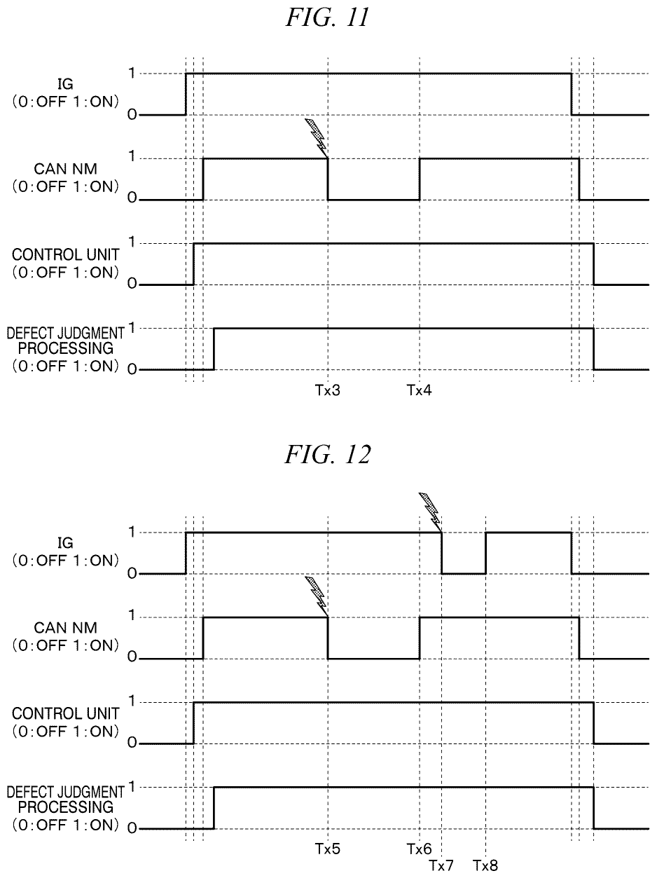

FIG. 11 is a timing chart (3) showing transition between the input state and the actuation state of a signal of the control unit 26. Description will focus on points different from those in FIGS. 9 and 10. After the defect judgment processing has started, it is assumed that CAN NM becomes “0” during a period from a time T×3 to a time T×4. In this case as well, the control unit 26 maintains the actuation state.

### (Control Unit (4))

FIG. 12 is a timing chart (4) showing transition between the input state and the actuation state of a signal of the control unit 26. The description will focus on points different from those in FIGS. 9 to 11. After the defect judgment processing has started, it is assumed that CAN NM becomes “0” during a period from a time T×5 to a time T×6 and IG becomes “0” during a period from a time T×7 to a time T×8 after the time T×6. During a period from the time T×5 to the time T×8 as well, the control unit 26 maintains the actuation state.

### (Control Unit (5))

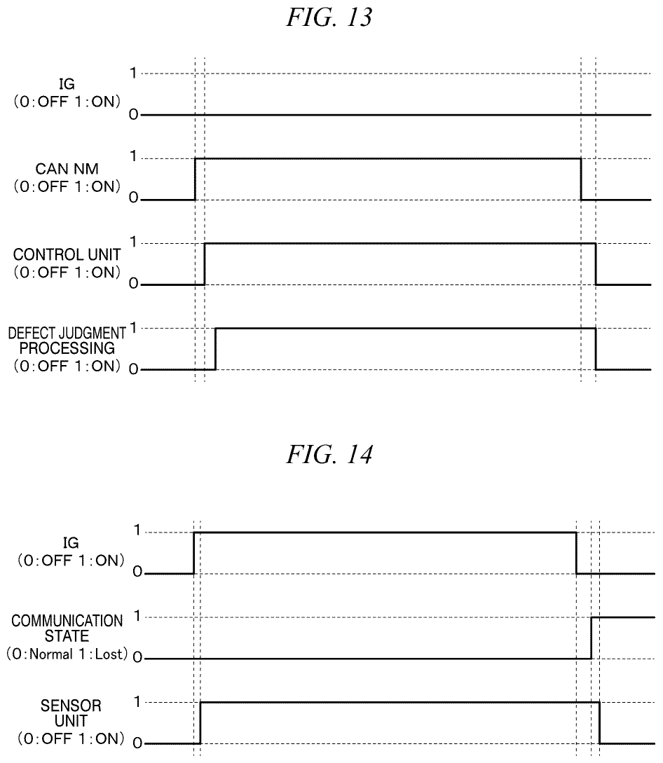

FIG. 13 is a timing chart (5) showing transition between the input state and the actuation state of a signal of the control unit 26. Description will focus on points different from those in FIGS. 9 to 12. In FIG. 13, IG “1” has not been input and the state of IG “0” is maintained. If CAN NM “1” is input, the control unit 26 starts to actuate, and the defect judgment processing is started. If CAN NM becomes “0”, actuation of the control unit 26 stops, and the defect judgment processing ends.

### [Timing Chart (2)]

### (Sensor Unit (1))

FIG. 14 is a timing chart (1) showing transition between an input state and an actuation state of a signal of the sensor unit 21. In the following description, a signal input to the first communication line C1A will be referred to as IG “1”. When the state of communication utilizing the second communication line C2A is normal, it will be referred to as “0”, and when the communication state is abnormal, it will be referred to as “1”. Abnormal denotes a state in which a signal of stopping actuation has been input from the control unit 26, or a state in which communication has been disconnected. The actuation state of the sensor unit 21 will be referred to as “1”, and the stopped state thereof will be referred to as “0”.

If IG “1” has been input, the sensor unit 21 is actuated. Thereafter, IG becomes “0”, and when it becomes “1” indicating that the state of communication is abnormal, the sensor unit 21 stops.

### (Sensor Unit (2))

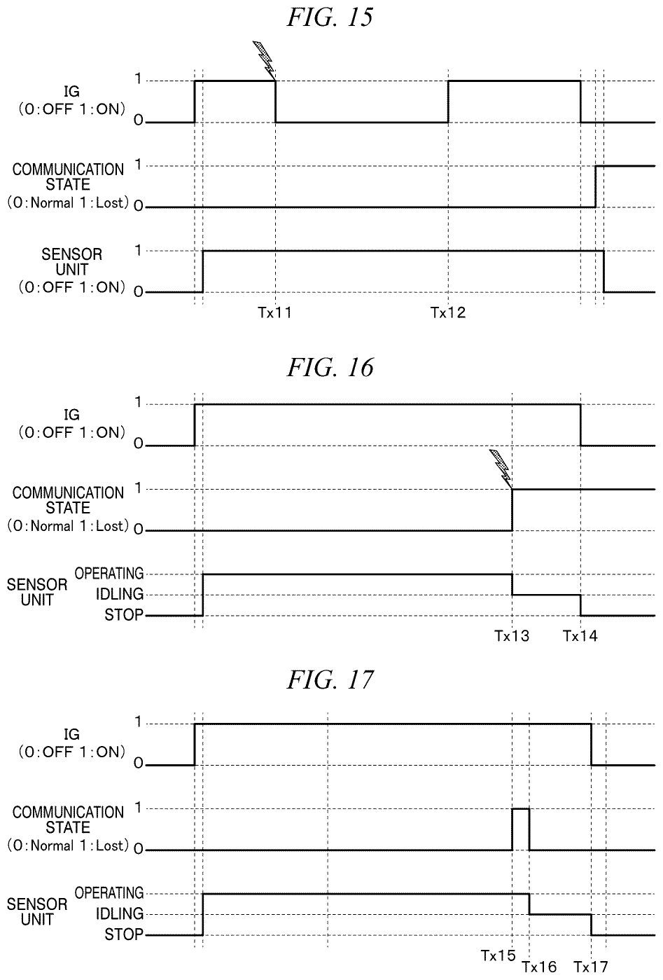

FIG. 15 is a timing chart (2) showing transition between the input state and the actuation state of a signal of the sensor unit 21. Description will focus on points different from those in FIG. 14. After the sensor unit 21 has been actuated, it is assumed that IG becomes “0” during a period from a time T×11 to a time T×12. In this case, actuation of the sensor unit 21 is maintained.

### (Sensor Unit (3))

FIG. 16 is a timing chart (3) showing transition between the input state and the actuation state of a signal of the sensor unit 21. Description will focus on points different from those in FIGS. 14 and 15. In FIG. 16, the sensor unit 21 is in any one of an actuated state, an idling state, and a stopped state. An idling state denotes that the sensor unit 21 is not in a state of executing the processing and only the power is in a state of being turned on. After the sensor unit 21 has been actuated, when the communication state becomes the abnormal state “1” at a time T×13, the sensor unit 21 transitions to an idling state. Thereafter, if IG becomes “0” at a time T×14, actuation of the sensor unit 21 stops.

### (Sensor Unit (4))

FIG. 17 is a timing chart (4) showing transition between the input state and the actuation state of a signal of the sensor unit 21. Description will focus on points different from those in FIG. 16. After the sensor unit 21 has been actuated, when the communication state becomes an abnormal state “1” during a period from a time T×15 to a time T×16, the sensor unit 21 transitions to an idling state. Thereafter, if IG becomes “0” at a time T×17, actuation of the sensor unit 21 stops.

In the present embodiment, a target has been described as being related to the LIDAR unit 20. However, instead of this, a target may be related to a radar unit. In this case, the sensor unit 21 is a unit transmitting and receiving radar, and the control unit 26 a control unit recognizing the location, the kind, and the like of a target object on the basis of information obtained from the sensor unit 21.

According to the embodiment described above, it is possible for the vehicle control device to appropriately control an actuation state of a function of a target by actuating the target when a first signal indicating the instruction for power in the first communication state has been input to the first instruction line or when the second communication state is normal, and by not actuating the target when the first signal indicating the instruction for power in the first communication state has not been input to the first instruction line and the second communication state is not normal.

Hereinabove, a form for performing the present invention has been described using the embodiment. However, the present invention is not limited to such an embodiment at all, and various modifications and replacements can be added within a range not departing from the gist of the present invention.

What is claimed is:

1. A vehicle control device comprising:
a storage medium storing computer-readable instructions; and
at least one processor connected to the storage medium,
wherein the processor executes the computer-readable instructions to:
acquire a first communication state of a first instruction line which is connected to a target utilized for controlling a vehicle and issues an instruction for power for the entire vehicle separately from a power supply line for supplying power to the target,
acquire a second communication state of a second instruction line which is connected to the target and differs from the power supply line and the first instruction line,
actuate the target when a first signal indicating the instruction for power in the first communication state has been input to the first instruction line or when the second communication state is normal, and
not actuate the target when the first signal indicating the instruction for power in the first communication state has not been input to the first instruction line and the second communication state is not normal.

2. The vehicle control device according to claim 1,
wherein the second communication state being normal denotes that a management control device connected to the second instruction line and controlling traveling of the vehicle has acquired a second signal input to the second instruction line.

3. The vehicle control device according to claim 1,
wherein the processor executes the computer-readable instructions to:
activate the target when the first signal has been input,
continue activation of the target when the first signal has been input or when the second communication state is normal, and
stop actuation of the target when the first signal has not been input and the second communication state is not normal.

4. The vehicle control device according to claim 3,
wherein the target is a first target serving as a sensor, and
the second instruction line is connected to the first target and a second target serving as a controller for controlling the sensor.

5. The vehicle control device according to claim 4,
wherein the processor executes the computer-readable instructions to:
update a program, which is related to the first target and the second target and is stored in the second target, and not actuate the first target when the program stored in the second target is updated.

6. The vehicle control device according to claim 1,
wherein the target is a first target serving as a sensor of a LIDAR unit having a light emitter, and
the second instruction line is connected to the first target and a second target serving as a controller for controlling the sensor of the LIDAR unit.

7. The vehicle control device according to claim 1,
wherein the processor executes the computer-readable instructions to:
activate the target when the first signal has been input or when a management control device connected to the second instruction line and controlling traveling of the vehicle has acquired a second signal input to the second instruction line,
continue activation of the target when the first signal or the second signal has been input, and
stop actuation of the target when the first signal and the second signal have not been input.

8. The vehicle control device according to claim 7,
wherein the target is a first target serving as a control device controlling a sensor, and
the second instruction line is connected to the first target and a second target serving as a management control device controlling traveling of the vehicle.

9. A vehicle control device comprising:
a storage medium storing computer-readable instructions; and
at least one processor connected to the storage medium,
wherein the processor executes the computer-readable instructions to:
acquire an input state of a first signal indicating that a power system of a vehicle has been activated with respect to a first instruction line connected to a sensor of a LIDAR unit, and a communication state of a second instruction line connected to a controller controlling the sensor of the LIDAR unit and the sensor,
maintain a state in which the sensor is actuated when the first signal has been input or the communication state is normal, and
stop actuation of the sensor when the first signal has not been input and the communication state is not normal.

10. A vehicle control device comprising:
a storage medium storing computer-readable instructions; and
at least one processor connected to the storage medium,
wherein the processor executes the computer-readable instructions to:
acquire an input state of a first signal indicating that a power system of a vehicle has been activated with respect to a first instruction line connected to a controller controlling a sensor of a LIDAR unit, and an input state of a second signal related to a communication state with respect to a second instruction line connected to the controller of the LIDAR unit and a management control device controlling traveling of the vehicle,
maintain a state in which the controller is actuated when the first signal has been input or the second signal has been input, and
stop actuation of the controller when the first signal has not been input and the second signal has not been input.
